(19) United States
(12) Patent Application Publication
(10) Pub. No.: US 2013/0024276 A1
(43) Pub. Date: Jan. 24, 2013

(54) METHOD AND SYSTEM FOR SELECTING WEB ADVERTISEMENTS TO OPTIMIZE REVENUE

(71) Applicants: Gajendra Nishad KAMAT, Bangalore (IN); Narayan L. Bhamidipati, Bangalore (IN); Rushi P. Bhatt, Surat (IN)

(72) Inventors: Gajendra Nishad KAMAT, Bangalore (IN); Narayan L. Bhamidipati, Bangalore (IN); Rushi P. Bhatt, Surat (IN)

(73) Assignee: Yahoo! Inc., Sunnyvale, CA (US)

(21) Appl. No.: 13/186,492

(22) Filed: Jul. 20, 2011

(51) Int. Cl. G06Q 30/02

(52) U.S. Cl. 705/14.46

(57) ABSTRACT

A method and system for selecting web advertisements to optimize revenue. The method includes signing a plurality of deals with one or more advertisers. An index of a plurality of web advertisements for the plurality of deals is created based on a plurality of parameters. A group of web advertisements is selected from the index for a group of deals based on corresponding index values. The group of web advertisements is displayed for the group of deals. A predetermined number of user sign-ups are obtained within a predefined time period from one or more users for each deal of the group of deals. Payment is received upon activation of each deal. The system includes one or more electronic devices, a communication interface, a memory that stores instructions, and a processor that is responsive to the instructions.

### TECHNICAL FIELD

Embodiments of the disclosure relate to the field of selecting web advertisements to optimize revenue.

### BACKGROUND

Web advertising is primarily used for promoting or selling a variety of products and services of different advertisers. Group deals are usually signed between an advertiser and a publisher to display web advertisements of the advertiser. The web advertisements are digital advertisements displayed on a web page of the publisher. The web advertising involves displaying each web advertisement in a sequence to multiple users. However, only few deals of the displayed web advertisements are activated. For a group deal, the publisher receives revenue from the advertiser based on one or more pricing models, for example a fixed number of impressions (cost-per-impression, CPM), upon a click (cost-per-click, CPC), or upon a user ending up making a transaction (cost-per-action, CPA). However, in each of the above pricing models, the advertiser pays the publisher even if goods of the advertiser are not completely sold. Hence, risk borne by the advertiser tends to become higher as there is no guarantee that the goods will completely be sold out thereby denying the advertiser to buy an increased amount of goods from a supplier. Further, the publisher needs to keep being paid for each good that is sold.

In the light of the foregoing discussion, there is a need for a method and system for an efficient technique to decrease the risk of the advertiser and select the web advertisements to optimize revenue of the publisher.

### SUMMARY

The above-mentioned needs are met by a method, a computer program product and a system for selecting web advertisements to optimize revenue.

An example of a method of selecting web advertisements to optimize revenue includes signing a plurality of deals with one or more advertisers. The method also includes creating an index of a plurality of web advertisements for the plurality of deals based on a plurality of parameters. The method further includes selecting a group of web advertisements from the index for a group of deals based on corresponding index values. Further, the method includes displaying the group of web advertisements for the group of deals. The method also includes obtaining a predetermined number of user sign-ups within a predefined time period from one or more users for each deal of the group of deals. Moreover, the method includes receiving payment upon activation of each deal.

An example of a computer program product stored on a non-transitory computer-readable medium that when executed by a processor, performs a method of selecting web advertisements to optimize revenue includes signing a plurality of deals with one or more advertisers and creating an index of a plurality of web advertisements for the plurality of deals based on a plurality of parameters. The computer program product also includes selecting a group of web advertisements from the index for a group of deals based on corresponding index values. The computer program product further includes displaying the group of web advertisements for the group of deals. Further, the computer program product includes obtaining a predetermined number of user sign-ups within a predefined time period from one or more users for each deal of the group of deals. Moreover, the computer program product includes receiving payment upon activation of each deal.

An example of a system for selecting web advertisements to optimize revenue includes one or more electronic devices. The system also includes a communication interface in electronic communication with the one or more electronic devices. The system further includes a memory that stores instructions. Further, the system includes a processor responsive to the instructions to sign a plurality of deals with one or more advertisers, to create an index of a plurality of web advertisements for the plurality of deals based on a plurality of parameters, to select a group of web advertisements from the index for a group of deals based on corresponding index values, to display the group of web advertisements for the group of deals, to obtain a predetermined number of user sign-ups within a predefined time period from one or more users for each deal of the group of deals, and to receive payment upon activation of each deal.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment; and

FIG. 3 is a flowchart illustrating a method of selecting web advertisements to optimize revenue, in accordance with one embodiment.

### DETAILED DESCRIPTION OF THE EMBODIMENTS

The above-mentioned needs are met by a method, computer program product and system for selecting web advertisements to optimize revenue. The following detailed description is intended to provide example implementations to one of ordinary skill in the art, and is not intended to limit the invention to the explicit disclosure, as one or ordinary skill in the art will understand that variations can be substituted that are within the scope of the invention as described.

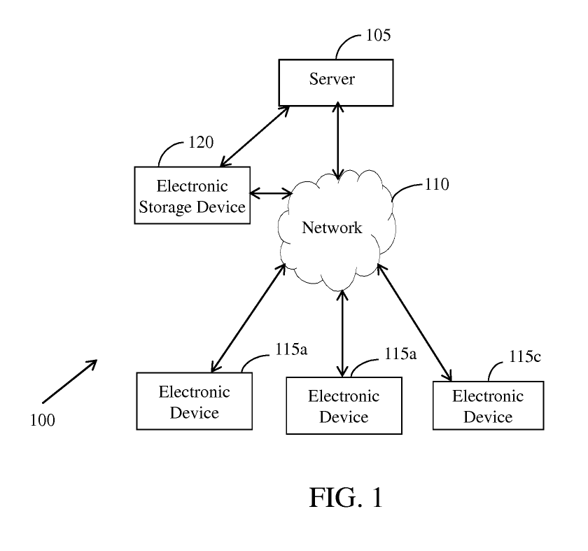

FIG. 1 is a block diagram of an environment 100, in accordance with which various embodiments can be implemented.

The environment 100 includes a server 105 connected to a network 110. The environment 100 further includes one or more electronic devices, for example an electronic device 115a, an electronic device 115b and an electronic device 115c, which can communicate with each other through the network 110. Examples of the electronic devices include, but are not limited to, computers, mobile devices, laptops, palmtops, hand held devices, telecommunication devices, and personal digital assistants (PDAs).

The electronic devices can also communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example web advertisements.

In some embodiments, different electronic storage devices are used for storing the information.

One or more advertisers sign deals with a publisher, for example Yahoo!®, via the server 105, for example the Yahoo!® server, through the network 110. Each advertiser provides a plurality of parameters associated with corresponding deal to the server 105 of the publisher. The server 105 then creates an index of a plurality of web advertisements for the deals based on the parameters. The server 105 further selects a group of web advertisements from the index for a group of deals based on corresponding index values. The server 105 displays the group of web advertisements for the group of deals. The group of web advertisements is displayed on a web page. A user of an electronic device, for example the electronic device 115a, can access the web page via the electronic device 115a and views the group of web advertisements that is displayed on the web page. The user can then make a user sign-up for any deal in the group of deals. The publisher thus obtains a predetermined number of user sign-ups within a predefined time period from one or more users for each deal in the group of deals. The deal is activated if a plurality of user sign-ups equals or is greater than the predetermined number of user sign-ups within the predefined time period. The publisher further receives payment only upon activation of each deal.

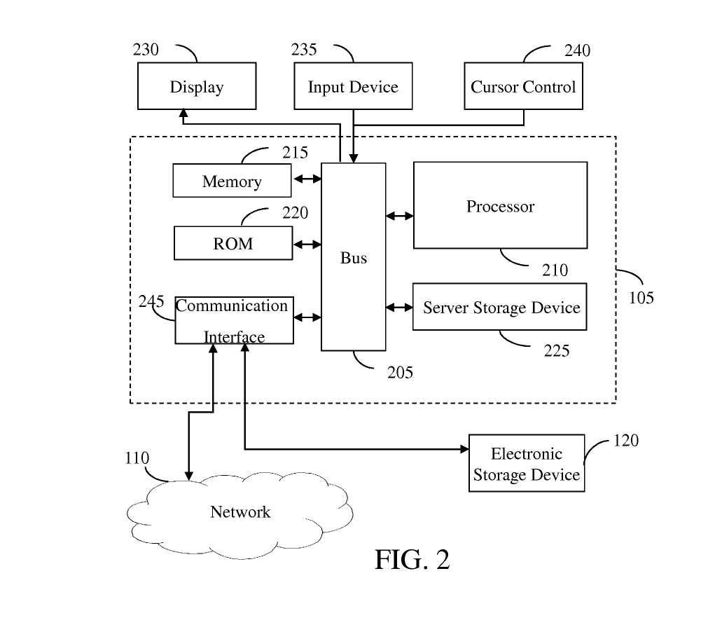

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A server storage device 225, for example a magnetic disk or optical disk, is provided and coupled to the bus 205 for storing information, for example information associated with deals signed, a plurality of parameters, and a plurality of user sign-ups.

The server 105 can be coupled via the bus 205 to a display 230, for example a cathode ray tube (CRT), and liquid crystal display (LCD) for displaying web advertisements to the user. An input device 235, including alphanumeric and other keys, is coupled to bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of server 105 for implementing the techniques described herein. In some embodiments, the techniques are performed by the server 105 in response to the processor 210 executing instructions included in the memory 215. Such instructions can be read into the memory 215 from another machine-readable medium, for example the server storage device 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the server storage device 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the server storage device 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the web advertisements of a plurality of advertisers.

In some embodiments, the server 105, for example a Yahoo !® server, receives a plurality of parameters once a publisher, for example Yahoo!®, signs multiple deals with one or more advertisers. The server 105 creates an index of a plurality of web advertisements for the deals based on a plurality of parameters. The server 105 then selects a group of web advertisements from the index for a group of deals based on corresponding index values. The server 105 displays the group of web advertisements for the group of deals. The server 105 then obtains a plurality of user sign-ups for the deal. The server 105 further receives payment upon activation of the deal.

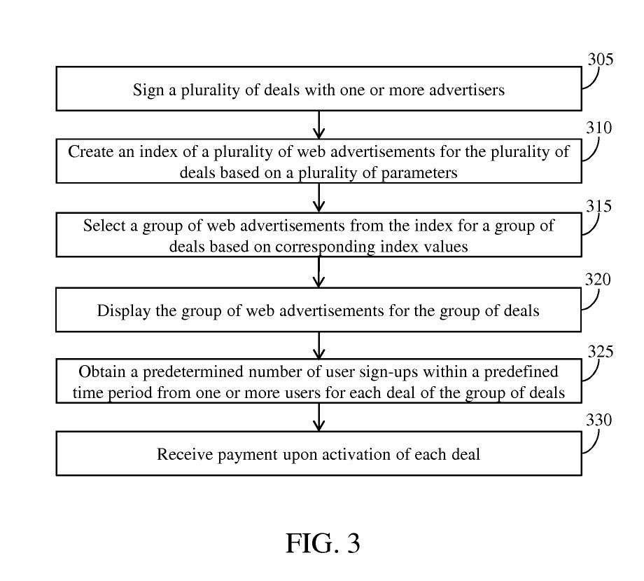

FIG. 3 is a flowchart illustrating a method of selecting web advertisements to optimize revenue, in accordance with one embodiment.

At step 305, a plurality of deals is signed with one or more advertisers. A publisher, for example Yahoo!®, can sign the deals with the advertisers. Each advertiser approaches the publisher in order to sell goods or services to a plurality of users. Each good or service purchased by a user translates to one user sign-up or user conversion. The deals are signed between the publisher and the advertisers such that the publisher receives payment only if the goods of the advertisers are completely sold.

In some embodiments, the deals are signed based on a cost-per-groupsell (CPG) pricing model.

At step 310, an index of a plurality of web advertisements for the plurality of deals is created based on a plurality of parameters. The publisher receives the parameters that are specified by each advertiser for the deals. Examples of the parameters include, but are not limited to, a predetermined number of user sign-ups, a predetermined number of goods to be sold, the revenue to be received for occurrence of the predetermined number of user sign-ups, and a predefined time period in addition to one or more deal specifics.

At step 315, a group of web advertisements is selected from the index for a group of deals based on corresponding index values. The group of web advertisements is selected such that the index values are higher as compared to other index values.

In some embodiments, the group of web advertisements is selected based on one or more of probability of obtaining a user sign-up, probability of displaying a web advertisement of a corresponding web advertiser, and probability of the deal being activated.

If the publisher determines that when a deal is activated, value brought by a web advertisement is high then index value of the web advertisement is higher and can be displayed first. Similarly, the index value of the web advertisement is higher if number of the goods to be sold is less for a particular deal. The web advertisement can also be displayed first if the publisher determines that the users are more likely to sign-up for that web advertisement.

In some embodiments, the group of web advertisements is based on one or more of a cost-per-action (CPA) pricing model, a cost-per-click (CPC) pricing model, a cost-per-impression (CPM) pricing model, and the CPG pricing model.

At step 320, the group of web advertisements is displayed for the group of deals. The publisher displays the group of web advertisements, either together or in a sequence, on an associated web page along with web content. The publisher selects the group of web advertisements to be displayed based on an algorithm.

In some embodiments, the publisher decides if the web advertisements from one advertiser should be displayed until the goods are completely sold or to display web advertisements from another advertiser that has signed a deal on similar terms and conditions.

Examples of the algorithm used in the present disclosure and methods of selecting the group of web advertisements for display are described in publication entitled, “A METHOD FOR OPTIMIZING REVENUE TO A PUBLISHER UNDER A CHUNKED REWARD AD-PRICING MODEL” by Narayan L Bhamidipati, Rushi P Bhatt, and Dinesh Garg, published in IP.com Prior Art Database on 17 Feb. 2011, IPCOM000204185D, and assigned to Yahoo! Inc. which is incorporated herein by reference in its entirety.

At step 325, a predetermined number of user sign-ups are obtained within a predefined time period from one or more users for each deal of the group of deals. The publisher obtains the user sign-ups from different users. Each purchase made by a user is translated to a corresponding user sign-up or user conversion by the server, for example the server 105, of the publisher.

At step 330, payment is received upon activation of each deal.

The deal is activated if a plurality of user sign-ups equals the predetermined number of user sign-ups within the predefined time period. The predetermined number of user sign-ups and the predefined time period for a deal is specified by a corresponding advertiser.

In some embodiments, the deal is inactivated if the user sign-ups are less than the predetermined number of user sign-ups within the predefined time period.

According to the deal that is initially signed, the publisher does not receive any payment if the deal is inactivated.

In one example, an advertiser Al signs a deal with Yahoo!® to sell a group of goods or a service. An index of a plurality of web advertisements for a plurality of deals is created based on a plurality of parameters. A group of web advertisements is selected from the index for a group of deals based on corresponding index values. The group of web advertisements is displayed for the group of deals. A web advertisement corresponding to the deal can also be displayed on the web page of Yahoo!®. The users that view the web advertisement can opt to purchase one or more of the goods or sign-up for the service, probability of which is p_i for the advertiser A_i. Each purchase or user sign-up translates to one user conversion. If n_i users make purchases or user sign-ups related to the deal offered by the advertiser A_i, the deal is activated or holds good and discount is provided to the n_i users. Yahoo!® further receives payment r_i for providing a predetermined number of user sign-ups in a predefined time period T. The payment is based on the CPG pricing model. The CPG of the advertiser A_i is c_i. The CPG pricing model is risk-free to the advertiser as the deal is activated only if the predetermined number of user sign-ups is obtained from the users. If the predetermined number of user sign-ups cannot be obtained from the users, the advertiser need not provide the payment to the publisher.

The algorithm used in the present disclosure involves a plurality of indices, for example c_i, p_i, and n_i, which are simple. The indices enable the publisher to select an appropriate web advertisement to be displayed such that revenue of the publisher is optimized. In one example, the indices can be used to represent c_i * p_i/n_i. in another example, the indices can be used to represent c_i * P.

In some embodiments, the publisher repeatedly displays the web advertisement of the advertiser A_i until the goods are completely sold out or a number of users sign-up for the service. The deal of the advertiser A_i also holds good if only the web advertisement of the advertiser A_i is displayed.

In some embodiments, if the indices for the web advertisement of the advertiser A_i are greater than expected cost per impression (CPM) of the other web advertisements, the web advertisement of the advertiser A_i is selected for display instead of the other web advertisements.

The algorithm used in the present disclosure enables selection of web advertisements to optimize the revenue. The risk of the advertisers is reduced as the publisher, for example Yahoo!®, bears complete risk. The advertisers also acquire information regarding daily budget requirements. The optimized revenue has a theoretical guarantee which in turn minimizes the risk borne by the publisher. Marketplace fragmentation is avoided as CPG deals cannot be converted. User sign-ups on some deals are reduced if the publisher realizes that such deals eventually get inactivated. The revenue can also be charged at an increased rate as the publisher assumes higher risk. In this manner, the publisher can maximize the revenue obtained from the predetermined number of user sign-ups.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of selecting web advertisements to optimize revenue, the method comprising:
signing a plurality of deals with one or more advertisers;
creating an index of a plurality of web advertisements for the plurality of deals based on a plurality of parameters;
selecting a group of web advertisements from the index for a group of deals based on corresponding index values;
displaying the group of web advertisements for the group of deals;
obtaining a predetermined number of user sign-ups within a predefined time period from one or more users for each deal of the group of deals; and
receiving payment upon activation of each deal.

2. The method as claimed in claim 1 and further comprising:
activating a deal if a plurality of user sign-ups is one of equal to and greater than the predetermined number of user sign-ups within the predefined time period.

3. The method as claimed in claim 2 and further comprising:
inactivating the deal if the plurality of user sign-ups is less than the predetermined number of user sign-ups within the predefined time period.

4. The method as claimed in claim 1, wherein the predetermined number of user sign-ups and the predefined time period for a deal is specified by a corresponding advertiser.

5. The method as claimed in claim 1, wherein the deal is associated with one of
marketing of one or more goods, and
marketing of a service.

6. The method as claimed in claim 1, wherein the plurality of parameters comprises the predetermined number of user sign-ups, a predetermined number of goods to be sold, the revenue to be received for occurrence of the predetermined number of user sign-ups, and the predefined time period in addition to one or more deal specifics.

7. The method as claimed in claim 1, wherein the group of web advertisements is displayed on a web page along with web content.

8. The method as claimed in claim 1, wherein the plurality of deals is signed based on a cost-per-groupsell (CPG) pricing model.

9. The method as claimed in claim 1, wherein the group of web advertisements is based on one or more of a cost-per-action (CPA) pricing model, a cost-per-click (CPC) pricing model, a cost-per-impression (CPM) pricing model, and a cost-per-groupsell (CPG) pricing model.

10. The method as claimed in claim 1, wherein selecting the group of web advertisements is based on an algorithm.

11. The method as claimed in claim 1, wherein selecting the group of web advertisements is based on one or more of
probability of obtaining a user sign-up,
probability of displaying a web advertisement of a corresponding web advertiser, and
probability of the deal being activated.

12. A computer program product stored on a non-transitory computer-readable medium that when executed by a processor, performs a method of selecting web advertisements to optimize revenue, comprising:
signing a plurality of deals with one or more advertisers;
creating an index of a plurality of web advertisements for the plurality of deals based on a plurality of parameters;
selecting a group of web advertisements from the index for a group of deals based on corresponding index values;
displaying the group of web advertisements for the group of deals;
obtaining a predetermined number of user sign-ups within a predefined time period from one or more users for each deal of the group of deals; and
receiving payment upon activation of each deal.

13. The computer program product as claimed in claim 12 and further comprising:
activating a deal if a plurality of user sign-ups is one of equal to and greater than the predetermined number of user sign-ups within the predefined time period.

14. The computer program product as claimed in claim 13 and further comprising:
inactivating the deal if the plurality of user sign-ups is less than the predetermined number of user sign-ups within the predefined time period.

15. The computer program product as claimed in claim 12, wherein the predetermined number of user sign-ups and the predefined time period for a deal is specified by a corresponding advertiser.

16. The computer program product as claimed in claim 12, wherein the deal is associated with one of
marketing of one or more goods, and
marketing of a service.

17. The computer program product as claimed in claim 12, wherein the plurality of parameters comprises the predetermined number of user sign-ups, a predetermined number of goods to be sold, the revenue to be received for occurrence of the predetermined number of user sign-ups, and the predefined time period in addition to one or more deal specifics.

18. The computer program product as claimed in claim 12, wherein the group of web advertisements is displayed on a web page along with different web advertisements and web content.

19. The computer program product as claimed in claim 12, wherein the plurality of deals is signed based on a cost-per-groupsell (CPG) pricing model.

20. The computer program product as claimed in claim 12, wherein the group of web advertisements is based on one or more of a cost-per-action (CPA) pricing model, a cost-per-click (CPC) pricing model, a cost-per-impression (CPM) pricing model, and a cost-per-groupsell (CPG) pricing model.

21. The computer program product as claimed in claim 12, wherein selecting the group of web advertisements is based on an algorithm.

22. The computer program product as claimed in claim 12, wherein selecting the group of web advertisements is based on one or more of
probability of obtaining a user sign-up,
probability of displaying a web advertisement of a corresponding web advertiser, and
probability of the deal being activated.

23. A system for selecting web advertisements to optimize revenue, the system comprising:
one or more electronic devices;
a communication interface in electronic communication with the one or more electronic devices;
a memory that stores instructions; and
a processor responsive to the instructions to
sign a plurality of deals with one or more advertisers;
create an index of a plurality of web advertisements for the plurality of deals based on a plurality of parameters;
select a group of web advertisements from the index for a group of deals based on corresponding index values;
display the group of web advertisements for the group of deals;
obtain a predetermined number of user sign-ups within a predefined time period from one or more users for each deal of the group of deals; and
receive payment upon activation of each deal.

24. The system as claimed in claim 23 and further comprising
an electronic storage device that stores the plurality of web advertisements.

25. The system as claimed in claim 23, wherein the processor is further responsive to the instructions to
activate a deal if a plurality of user sign-ups is one of equal to and greater than the predetermined number of user sign-ups within the predefined time period; and
inactivate the deal if the plurality of user sign-ups is less than the predetermined number of user sign-ups within the predefined time period.

26. The system as claimed in claim 23, wherein the plurality of parameters comprises the predetermined number of user sign-ups, a predetermined number of goods to be sold, the revenue to be received for occurrence of the predetermined number of user sign-ups, and the predefined time period in addition to one or more deal specifics.
